(19) United States
(12) Patent Application Publication
(10) Pub. No.: US 2026/0248266 A1
(43) Pub. Date: Aug. 27, 2026

(54) Protective Tape Measure Retention Device and Method of Manufacture

(71) Applicant: Dean Barlow, Keensburg, CO (US)

(72) Inventor: Dean Barlow, Keensburg, CO (US)

(21) Appl. No.: 19/547,843

(22) Filed: Feb. 24, 2026

Related U.S. Application Data
(60) Provisional application No. 63/763,095, filed on Feb. 25, 2025.

(51) Int. Cl. A45F 5/02; A45F 5/00; B33Y 80/00; G01B 3/1071

(52) U.S. Cl. CPC A45F 5/022; A45F 5/1575; B33Y 80/00; G01B 3/1071; G01B 2003/1074

(57) ABSTRACT

A protective tape measure retention device includes a unitary body formed from a single piece of rigid plate material with first and second substantially parallel aspects connected by a teardrop-shaped bend at a proximal end and a crimped portion at the distal end. The teardrop-shaped bend defines an interior nesting cavity configured to receive and nest the retention clip of a tape measure therein. A retention bar extends transversely within the interior nesting cavity, configured to engage the tape measure clip through metal-on-metal contact such that the tape measure is retained without direct contact between the clip and the user's clothing. The device features graduated spacing between the parallel aspects creating a wedge engagement with the pocket fabric, and non-magnetic construction to prevent attraction of ferromagnetic debris. The device may be manufactured through traditional metal forming and welding or through additive manufacturing processes that produce a metallurgically continuous unitary body.

### CROSS-REFERENCE TO RELATED APPLICATION

This application claims the benefit of U.S. Provisional Patent Application No. 63/763,095, filed Feb. 25, 2025, entitled “Protective Tape Measure Retention Device and Method of Manufacture,” the entire disclosure of which is hereby incorporated by reference.

### FIELD OF THE INVENTION

The present invention relates generally to hand tool accessories and, more particularly, to a protective retention device configured for pocket-mounted carry of a tape measure that prevents damage to clothing while providing secure tool retention through a unitary rigid body with a teardrop-shaped geometry and an integrated mechanical retention interface.

### BACKGROUND OF THE INVENTION

Tape measures represent indispensable tools utilized extensively on a daily basis by construction professionals, contractors, tradespeople, and do-it-yourself enthusiasts across numerous industries and applications. However, the fundamental need for these tools to be readily portable and accessible has created several persistent and significant problems that existing solutions in the marketplace have failed to adequately address or resolve.

One of the most prevalent and costly issues encountered by users is the accelerated deterioration and damage to clothing, with particular severity in pocket areas, resulting from regular tape measure carrying and usage. The metal retention clips found on standard tape measures, while serving an essential functional purpose, frequently incorporate sharp edges and exhibit considerable flexibility during normal movement and use. This combination of characteristics leads to rapid fabric degradation, torn clothing, and permanent damage to garments after even minimal periods of use. The constant insertion and extraction of the tool, combined with the dynamic oscillations of the heavy tool body during the user's gait, create a “sawing” effect on the fabric fibers. For construction professionals, the economic impact of frequently replacing damaged work clothing represents a substantial overhead cost that existing solutions have failed to adequately resolve.

The marketplace currently offers various carrying solutions attempting to address these challenges, but each presents significant operational drawbacks and limitations. Belt-mounted retention systems, while common, tend to be unnecessarily bulky, frequently cause discomfort or injury from repeated contact during movement, and fundamentally require the user to wear a belt—a requirement that proves impractical or impossible for workers utilizing overalls or suspender-based clothing systems.

Magnetic retention devices, another attempted solution, introduce their own unique set of problems and limitations. While appearing to offer convenience, these magnetic systems inherently attract all metallic objects in their vicinity, including nails, screws, metal filings, and other ferromagnetic debris commonly present on construction jobsites. This attraction of ferromagnetic debris creates significant practical difficulties, including potential tool detachment, clothing staining, and interference with tool function. Furthermore, magnetic retention systems frequently provide insufficient holding strength, resulting in unexpected and potentially dangerous detachment of tape measures during use. The current industry trend toward magnetic securement, while perceived as “high-tech,” fails to account for these critical real-world failure modes in industrial environments.

Currently available pouch-style holders and multi-tool carrying systems, while offering some degree of protection, typically manifest as cumbersome and excessively large accessories. These solutions generally add unnecessary bulk and weight to the user's equipment, significantly impeding movement and reducing comfort during extended use periods. Additionally, many users express a strong preference for carrying only their tape measure without the added encumbrance of storage space for additional tools.

Existing pocket protectors and clip-type solutions have also failed to adequately address the problem. Traditional pocket protectors, originating from vinyl pen sheaths, lack the specialized geometric properties necessary to securely retain a heavy, dynamic tool like a tape measure. Standard wire-form clips and U-shaped radius bends, while known in the art, force the tool's retention clip into direct contact with the pocket fabric because the bend radius occupies the same spatial volume as the tool clip, pushing the tool away from the user's body rather than nesting the clip within a protective cavity. Surface-mount shields rely on the tool clip remaining on the exterior of the shield, providing no mechanical interface between the tool and the device.

The persistent issue of clothing damage caused by direct tape measure retention, combined with the substantial inadequacies of existing carrying solutions, represents a significant and costly problem across the construction, trades, and DIY industries. There remains an urgent need for a protective retention device that securely holds a tape measure while preventing the tool's clip from contacting and damaging the user's clothing.

### SUMMARY OF THE INVENTION

The present invention provides a protective tape measure retention device that addresses the longstanding problems of clothing damage and insecure tool retention through a unitary rigid body with a specifically engineered teardrop-shaped geometry. The device functions as a mechanical buffer between the tape measure's retention clip and the user's clothing, providing metal-on-metal tool engagement that eliminates direct contact between the clip and textile substrate.

In accordance with an aspect of the invention, the device comprises a single piece of rigid plate material formed into a clip configuration having first and second substantially parallel aspects connected by a teardrop-shaped bend at a proximal end. The teardrop-shaped bend defines an interior nesting cavity having an internal transverse volume specifically configured to receive and nest the retention clip of a hand tool therein. This nesting relationship is distinguished from prior art clip geometries in which the bend radius occupies the same spatial volume as a tool clip, thereby forcing the tool away from the user rather than capturing the clip within a protective interior space.

A retention bar extends transversely between inner surfaces of the first and second aspects and is positioned within the interior nesting cavity proximate the teardrop-shaped bend. The retention bar is configured to mechanically engage the retention clip of the hand tool such that the hand tool is retained by metal-on-metal contact with the retention bar rather than by contact with the textile substrate of the user's clothing. This mechanical buffer arrangement distributes the dynamic forces of the retained tool across the rigid body of the device rather than concentrating them on the pocket fabric.

The device further includes a graduated spacing between the first and second aspects that decreases from the teardrop-shaped bend toward a crimped distal end. In a preferred embodiment, the spacing ranges from approximately 0.5 inches at the teardrop-shaped bend to approximately 0.125 inches at the crimped portion. This graduated spacing creates a wedge engagement with the textile substrate of a pocket, providing a lead-in region that facilitates easy insertion and a retention region that provides secure anchoring. The dynamic retention curve created by this graduated profile allows the user to begin insertion without fighting the fabric while achieving high retention force at the final portion of travel.

The non-magnetic construction of the device, whether achieved through stainless steel, titanium alloy, or composite materials, prevents the attraction of ferromagnetic debris commonly present in industrial work environments—a critical failure mode in competing magnetic retention systems. The device may be manufactured through traditional metal forming and welding processes, or through advanced additive manufacturing methods such as selective laser melting (SLM) or direct metal laser sintering (DMLS), which produce a metallurgically continuous unitary body without weld joints at the retention bar interface.

### BRIEF DESCRIPTION OF THE DRAWINGS

FIG. 1 shows a top side view of a tape measure retention device according to an embodiment of the invention.

FIG. 2 illustrates a perspective view of the rear of the tape measure retention device in accordance with an embodiment, showing the teardrop-shaped bend profile and graduated spacing.

FIG. 3 depicts a top-down view of the front of the tape measure retention device in accordance with an embodiment.

FIG. 4 demonstrates the tape measure retention device in accordance with an embodiment installed in a pocket.

FIG. 5 presents a detailed view of the retention bar and crimped portion of the device in accordance with an embodiment with a tape measure engaged.

### DETAILED DESCRIPTION OF THE INVENTION

The following detailed description sets forth specific embodiments of the invention. These embodiments are described with sufficient detail to enable those skilled in the art to practice the invention. It is to be understood that other embodiments may be utilized and that changes may be made without departing from the scope of the invention. The following description should not be read as limiting the scope of the invention, as defined by the appended claims.

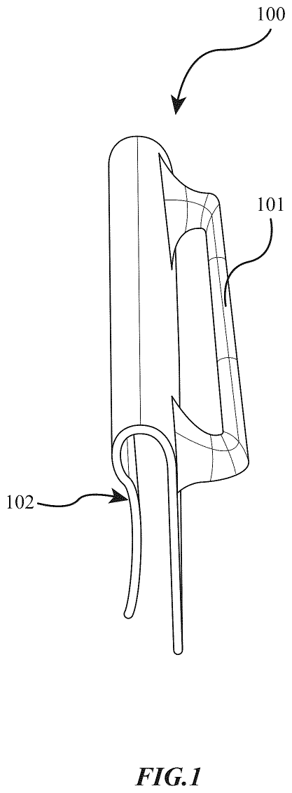

Referring now to the drawings, and more particularly to FIGS. 1-5, there is shown a tape measure retention device 100 according to embodiments of the invention. The device 100 comprises a unitary body formed from a single piece of rigid plate material that creates a protective mechanical buffer between a hand tool and a user's clothing.

FIG. 1 shows a top side view of the tape measure retention device 100, illustrating the overall system structure including a retention bar 101 and a back side portion 102. The device 100 comprises first and second aspects arranged in a substantially parallel configuration, formed from a single piece of rigid plate material. The plate material has a gauge thickness between approximately 0.0625 and 0.125 inches, which is distinguished from thin-gauge wire forms used in conventional clips and paper clips. The use of plate material provides the structural rigidity necessary to resist the dynamic multi-axial forces imparted by a retained tape measure during normal user movement.

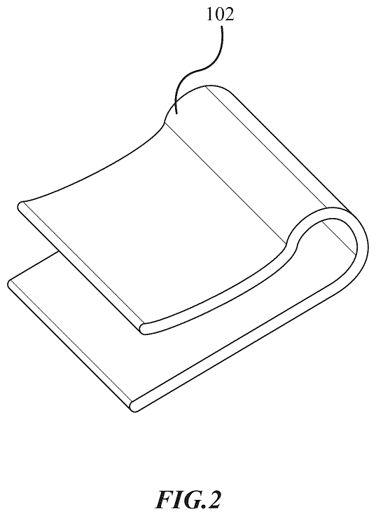

FIG. 2 provides a perspective view highlighting the back side 102 of the tape measure retention device 100, demonstrating the teardrop-shaped bend profile and the graduated spacing between the parallel aspects. The teardrop-shaped bend 110 at the proximal end of the device forms a distinctive teardrop or bubble shape when viewed from the side profile. Unlike conventional U-shaped or constant-radius bends found in prior art clips, the teardrop configuration defines an interior nesting cavity having an enlarged internal transverse volume. This interior nesting cavity is specifically configured to receive and nest the retention clip of a tape measure therein, such that the tape measure clip sits within the cavity of the device rather than against the user's pocket fabric. In a standard radius clip, the bend takes up the same spatial volume as the tool's clip, forcing the tool away from the user's body. The teardrop-shaped bend 110 of the present invention creates a bubble of interior volume that allows the tool's clip to sit inside the device's vertex, keeping the center of gravity closer to the user—a nesting relationship that solves the multi-axial stress problem of dynamic tool carry that traditional U-shaped clips cannot address.

The graduated spacing between the first and second aspects decreases from the teardrop-shaped bend 110 toward the crimped portion 115 at the distal end. In a preferred embodiment, the spacing ranges from approximately 0.5 inches at the teardrop-shaped bend 110 to approximately 0.125 inches at the crimped portion 115. This graduated spacing profile creates a wedge engagement with the textile substrate of a pocket. Conventionally, a clip with a 0.5-inch gap would be too loose to stay in a pocket. However, by crimping the distal end to 0.125 inches, the device achieves a lead-in wedge that allows the user to begin insertion without fighting the fabric while achieving high retention force at the final approximately 0.75 inches of travel. This dynamic retention curve is not taught by standard wire clips or flat shields.

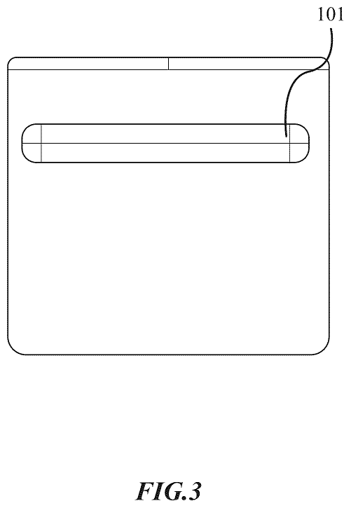

FIG. 3 presents a top-down view highlighting the tape measure retention device's 100 approximately 1.5-inch by 1.5-inch footprint dimensions. This footprint is specifically selected to correspond with typical front pocket dimensions of work wear and casual clothing, while providing sufficient surface area for stable lateral retention. The 1.5-inch width distributes the dynamic load of a retained tape measure (typically weighing 21 ounces or more for a 25-35 foot model) across a planar surface area rather than the line contact of a conventional spring-steel clip. This load distribution prevents the localized stress concentration that causes the “sawing” effect on fabric fibers observed with direct clip attachment.

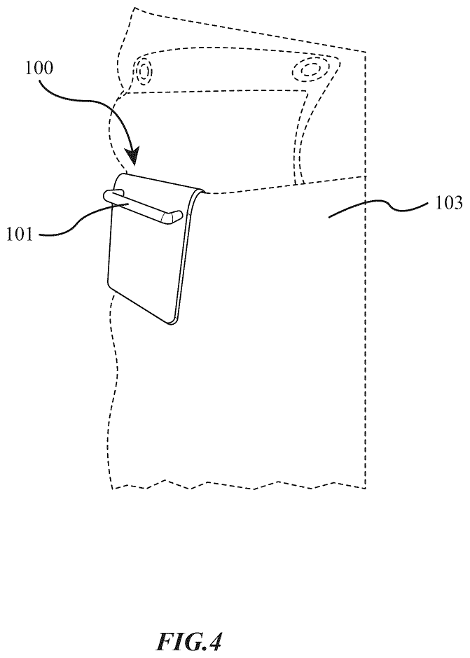

FIG. 4 illustrates the tape measure retention device 100 installed in a pocket with clothing material 103. The retention bar 101 is visible. The graduated spacing and crimped portion 115 work together to securely retain the device while preventing damage to the pocket material. The teardrop bend 110 and upper portion remain outside the pocket during use, while the lower portion including the crimped region is inserted into the pocket, providing secure anchoring through the wedge engagement of the graduated spacing profile.

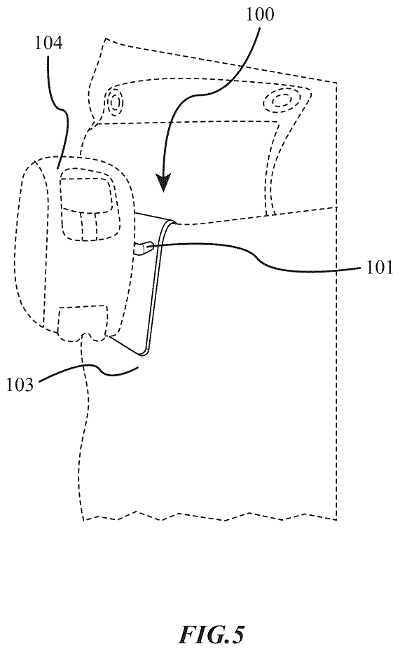

FIG. 5 presents a detailed view showing the tape measure retention device 100 with a tape measure 104 engaged with the retention bar 101. The pocket/clothing material 103 is visible, demonstrating the protective spacing that prevents direct contact between the tape measure clip and the clothing material. The tape measure clip nests within the interior cavity defined by the teardrop-shaped bend 110, engaging the retention bar 101 through metal-on-metal contact. The clothing material 103 is captured between the first and second aspects of the device below the retention bar 101, protected from the sharp edges and dynamic forces of the tape measure clip by the rigid body of the device.

The retention bar 150 is attached to the inner aspect of the tape measure retention device 100 at a position approximately 0.25 inches from the teardrop-shaped bend 110. The retention bar 150 extends transversely between inner surfaces of the first and second aspects, substantially across the width of the device. The retention bar 150 comprises a metal rod or bar stock having a diameter or thickness between approximately 0.125 and 0.25 inches, corresponding to the typical gap width found in commercial tape measure clips. The specific diameter selection allows for secure engagement while accommodating minor variations in clip designs across different tape measure manufacturers.

The positioning of the retention bar 150 within the interior nesting cavity of the teardrop-shaped bend 110 creates a mechanical buffer arrangement. When a tape measure clip engages the retention bar 150, the tool is held by metal-on-metal contact between the clip and the bar, rather than by friction between the clip and the user's clothing. The clothing material is captured between the parallel aspects of the device below the retention bar 150, completely isolated from the dynamic forces transmitted through the tape measure during normal use. This arrangement creates a mechanical buffer zone where the dynamic energy of the tool is absorbed by the rigid stainless steel body of the device rather than by the flexible textile fibers of the user's clothing.

The specific positioning of the retention bar 150 relative to the teardrop-shaped bend 110 creates an optimal leverage point for tape measure clips. The approximately 0.25-inch spacing from the bend ensures that the clip engages the bar at a position that maximizes retention force while allowing for intentional insertion and extraction. The retention bar 150 and the crimped portion 115 create a dual-retention mechanism—the bar retains the tool while the crimped portion retains the device in the pocket—that maintains security without damage to clothing.

The crimped region 115 at the distal end of the device features a spacing of approximately 0.125 inches between the parallel aspects. The crimped portion extends for approximately 0.75 inches along the length of the device. The spacing is precisely maintained through controlled forming operations during manufacture. Following the crimped region, the distal end of the outer aspect curves outward at approximately 15 degrees for a distance of approximately 0.5 inches, facilitating easier insertion into pockets while maintaining secure retention characteristics. This outward curve provides a smooth lead-in that guides the device into the pocket opening without catching or snagging on the pocket edge.

In a preferred embodiment, the tape measure retention device 100 is constructed from heavy gauge stainless steel, specifically an austenitic or ferritic stainless steel alloy selected for its superior strength, corrosion resistance, durability, and critically, its non-magnetic properties. The non-magnetic construction prevents the attraction of ferromagnetic debris—including nails, screws, metal filings, and other ferrous materials—commonly present in construction and industrial work environments. This represents a deliberate departure from the prevailing industry trend toward magnetic retention systems, which the inventor has identified as fundamentally flawed for jobsite use due to the attraction of metallic debris that causes tool detachment, clothing staining, and interference with tool function.

Alternative embodiments may utilize other rigid non-magnetic materials including titanium alloys, high-strength aluminum alloys, or fiber-reinforced composite materials such as carbon fiber/epoxy or glass fiber/polyamide composites, provided they maintain sufficient structural rigidity to retain their shape under normal use conditions. Material selection considers factors including yield strength, fatigue resistance, corrosion resistance, and non-magnetic character to ensure long-term durability in various working environments.

In a preferred embodiment, the primary structure of the tape measure retention device 100 is manufactured from a single piece of rectangular metal having initial dimensions of approximately 4 inches in length and 2 inches in width. The metal piece is bent over itself using standard metal bending techniques such as brake forming or roll forming to create the clip shape with two parallel aspects and the distinctive teardrop-shaped bend at the proximal end. The graduated spacing is achieved through controlled pressure application during the forming process. The crimped portion is created through a combination of pressing and forming operations that maintain material integrity while achieving the desired spacing profile.

The retention bar 150 is attached using welding techniques, preferably TIG welding, to create a permanent, high-strength metallurgical bond. The welding process ensures complete penetration while maintaining precise positioning of the bar at approximately 0.25 inches from the teardrop-shaped bend 110. The retention bar 150 is welded at both ends to the inner surfaces of the parallel aspects to provide maximum structural integrity. Alternative joining methods may include MIG welding for steel variants or specialized welding processes for alternative metals.

In alternative embodiments, additive manufacturing processes may be employed to produce the device as a single unified component in which the retention bar is metallurgically continuous with the body without a weld joint. The absence of a weld joint at the retention bar interface eliminates the heat-affected zone (HAZ) common in welded assemblies, providing superior fatigue resistance at the critical retention bar junction. This metallurgical continuity throughout the unitary body represents a structural advantage over traditionally manufactured versions in which the retention bar is a separate component joined by welding.

In an embodiment utilizing selective laser melting (SLM), metal powder, preferably stainless steel powder with particle sizes between 15-45 microns, is deposited in successive layers typically 20-60 microns thick. A high-powered laser, operating between 200-400 watts, selectively melts and fuses the powder particles according to the device's CAD geometry, with particular attention paid to the teardrop bend profile, retention bar integration, and crimped regions. Build parameters are optimized to achieve full density exceeding 99.5% and proper mechanical properties, including layer overlap of 30-50% and scan speeds between 600-1000 mm/s. Post-processing operations including stress relief heat treatment at approximately 650° C. for 1-2 hours, followed by surface finishing operations, are performed to achieve final material properties and surface characteristics.

In an embodiment utilizing direct metal laser sintering (DMLS), metal powder, preferably stainless steel powder with particle sizes ranging from 20-50 microns, is deposited in layers of 20-40 microns thickness using a precision recoating system. A focused laser beam, typically operating at 200-500 watts with a spot size of 50-100 microns, selectively sinters the powder particles according to the device's three-dimensional geometry. Process parameters are optimized to achieve density greater than 99% and desired mechanical properties, utilizing scan speeds of 700-1200 mm/s, hatch spacing of 0.1-0.15 mm, and layer overlap of 25-35%. Post-processing requirements include stress relief heat treatment at 600-700° C. for 1-2 hours in an inert atmosphere, followed by surface finishing operations.

Edge preparation and finishing represents a critical aspect of the manufacturing process. All edges and corners undergo a systematic rounding operation to eliminate sharp edges and potential snag points. The rounding may be accomplished through a combination of grinding and polishing operations using progressively finer abrasives to achieve a radius on all edges typically between 0.0625 and 0.125 inches. Alternatively, the rounding may be accomplished through stamping operations during initial forming, or partially incorporated into the initial design geometry for additively manufactured components. Critical areas include the outer edges of both parallel aspects, the teardrop bend region, and the distal end of the device. Surface finishing operations may include mechanical polishing, bead blasting, or vibratory finishing. In the preferred stainless steel embodiment, the device may undergo passivation treatment to enhance corrosion resistance.

In operation, the tape measure retention device 100 is partially inserted into a user's pocket, with the distal end including the crimped region 115 entering the pocket first. The graduated spacing profile guides the device smoothly into the pocket, with the outward-curved distal end facilitating entry. The crimped portion 115 engages the pocket fabric through the wedge effect of the graduated spacing, securing the device in place. The teardrop-shaped bend 110 and the retention bar 150 remain above the pocket line, accessible for tool engagement.

To retain a tape measure, the user clips the tape measure's standard retention clip over the retention bar 150. The clip nests within the interior cavity defined by the teardrop-shaped bend 110, engaging the retention bar 150 through metal-on-metal contact. The clothing material is captured between the parallel aspects of the device below the retention bar, completely isolated from the dynamic forces of the tape measure. During normal user movement, the dynamic oscillations and forces generated by the weight of the tape measure (typically 21 ounces or more) are absorbed by the rigid body of the device and distributed across the 1.5-inch by 1.5-inch footprint, rather than being concentrated along a single line of fabric contact as in conventional direct clip attachment.

While various embodiments of the invention have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art.

The terms “comprising,” “including,” and “having” are intended to be inclusive and mean that there may be additional elements other than the listed elements. Additionally, references to “one embodiment” or “an embodiment” are not intended to be interpreted as excluding the existence of additional embodiments that also incorporate the recited features. Numbers, percentages, ratios, or other values stated herein are intended to include that value, and also other values that are “about” or “approximately” the stated value, as would be appreciated by one of ordinary skill in the art.

The various embodiments described above can be combined to provide further embodiments. Aspects of the embodiments can be modified, if necessary, to employ concepts of the various patents, applications, and publications to provide yet further embodiments. These and other changes can be made to the embodiments in light of the above-detailed description. In general, the terms used in the claims should not be construed to limit the claims to the specific embodiments disclosed in the specification, but should be construed to include all possible embodiments along with the full scope of equivalents to which such claims are entitled.

What is claimed is:

1. A protective tool retention device for pocket-mounted hand tool carry, comprising:
a unitary body formed from a single piece of rigid plate material having a gauge thickness between approximately 0.0625 and 0.125 inches, the body comprising:
a first aspect and a second aspect arranged in a substantially parallel configuration;
a teardrop-shaped bend connecting the first and second aspects at a proximal end, the teardrop-shaped bend defining an interior nesting cavity having an internal transverse volume configured to receive and nest a retention clip of a hand tool therein;
a graduated spacing between the first and second aspects that decreases from the teardrop-shaped bend toward a distal end, providing a lead-in region adjacent the teardrop-shaped bend and a retention region adjacent the distal end; and
a retention bar extending transversely between inner surfaces of the first and second aspects and positioned within the interior nesting cavity proximate the teardrop-shaped bend, the retention bar configured to mechanically engage the retention clip of the hand tool such that the hand tool is retained by metal-on-metal contact with the retention bar rather than by contact with a textile substrate.

2. The device of claim 1, wherein the graduated spacing ranges from approximately 0.5 inches at the teardrop-shaped bend to approximately 0.125 inches at a crimped portion at the distal end.

3. The device of claim 1, wherein the retention bar is positioned approximately 0.25 inches from the teardrop-shaped bend.

4. The device of claim 1, wherein the unitary body has a top-down footprint of approximately 1.5 inches by 1.5 inches, the footprint sized to distribute the dynamic load of a retained hand tool across a planar surface area.

5. The device of claim 1, wherein the second aspect includes a distal end that curves outward at approximately 15 degrees for a distance of approximately 0.5 inches to facilitate insertion of the device into a pocket.

6. The device of claim 1, wherein the rigid plate material comprises a non-magnetic alloy selected to prevent attraction of ferromagnetic debris in an industrial work environment.

7. The device of claim 6, wherein the non-magnetic alloy comprises stainless steel.

8. A hand tool retention system for protecting a textile substrate from damage during tool carry, comprising:
a pocket-insertable retention device formed as a unitary body from a single piece of rigid non-magnetic material, the body defining:
a teardrop-shaped proximal bend forming an interior nesting cavity;
a graduated spacing between opposing parallel aspects of the body, the spacing decreasing from approximately 0.5 inches at the proximal bend to approximately 0.125 inches at a crimped distal region, the graduated spacing creating a wedge engagement with the textile substrate; and
a retention bar positioned within the interior nesting cavity and configured to engage a clip of a tape measure;
wherein, when the distal region is inserted into a pocket of a garment and a tape measure clip is engaged with the retention bar, the body spaces the tape measure clip from the textile substrate to prevent direct contact therebetween.

9. The system of claim 8, wherein the retention bar has a diameter or thickness between approximately 0.125 and 0.25 inches, corresponding to a gap width of commercial tape measure clips.

10. The system of claim 8, wherein the retention bar is positioned approximately 0.25 inches from the teardrop-shaped proximal bend.

11. The system of claim 8, wherein all edges and corners of the body are rounded to a radius between approximately 0.0625 and 0.125 inches to prevent snagging.

12. The system of claim 8, wherein the rigid non-magnetic material comprises one of: stainless steel; titanium alloy; aluminum alloy; or fiber-reinforced composite material.

13. The system of claim 8, wherein the body has a top-down footprint of approximately 1.5 inches by 1.5 inches.

14. A method of manufacturing a unitary tool retention device, comprising:
depositing successive layers of metal powder;
selectively fusing the metal powder layers using a directed energy source to form a unitary body comprising a first aspect and a second aspect in substantially parallel configuration, a teardrop-shaped bend connecting the first and second aspects at a proximal end, a retention bar integrally formed within an interior nesting cavity defined by the teardrop-shaped bend, and a graduated spacing between the first and second aspects that decreases from the teardrop-shaped bend toward a distal end; and
performing post-processing comprising stress relief heat treatment and surface finishing to round all edges and corners of the body;
wherein the retention bar is metallurgically continuous with the body without a weld joint.

15. The method of claim 14, wherein the metal powder comprises stainless steel powder having particle sizes between 15 and 45 microns.

16. The method of claim 14, wherein the directed energy source comprises a laser operating between 200 and 500 watts, and wherein the selectively fusing step comprises one of selective laser melting (SLM) or direct metal laser sintering (DMLS).

17. The method of claim 14, wherein the stress relief heat treatment is performed at a temperature between approximately 600° C. and 700° C. for approximately 1 to 2 hours.

18. A method of manufacturing a protective tool retention device, comprising:
forming a single piece of rigid plate material into a clip shape having first and second substantially parallel aspects connected by a teardrop-shaped bend at a proximal end;
creating a graduated spacing between the first and second aspects that decreases from the teardrop-shaped bend toward a distal end;
forming a crimped portion at the distal end where the first and second aspects are brought into closest proximity;
attaching a retention bar to an inner surface of the first aspect within an interior cavity defined by the teardrop-shaped bend; and
rounding all edges and corners of the device to prevent snagging.

19. The method of claim 18, wherein attaching the retention bar comprises TIG welding the retention bar at a position approximately 0.25 inches from the teardrop-shaped bend.

20. The method of claim 18, wherein forming the clip shape comprises one of brake forming or roll forming.
